(19) United States
(12) Patent Application Publication
(10) Pub. No.: US 2007/0096632 A1
(43) Pub. Date: May 3, 2007

(54) Parallel Full-Color Organic Light-Emitting Display Device and a Manufacturing Method Thereof

(75) Inventors: Chih-Ming Chin, Chu Nan (TW); Joel Chia-Yeh Chang, Chu Nan (TW); Wen-Jeng Lan, Chu Nan (TW); Chien-Chih Chiang, Chu Nan (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: UNIVISION TECHNOLOGY INC., Chu Nan (TW)

(21) Appl. No.: 11/539,254

(22) Filed: Oct. 6, 2006

(30) Foreign Application Priority Data
Oct. 27, 2005 (TW) 94137631

(51) Int. Cl. H01J 1/62

(52) U.S. Cl. 313/500

(57) ABSTRACT

An improved parallel full-color organic light-emitting display device and a manufacturing method thereof, having several pixels disposed on a substrate, each of the pixels includes a first electrode, a first organic light-emitting layer, a second organic light-emitting layer, a third organic light-emitting layer, a fourth organic light-emitting layer and a second electrode. The color filter is used to filter and randomly mix the various light sources of the organic light-emitting layers to achieve a full-color display.

### RELATED APPLICATIONS

The present application is based on, and claims priority from, Taiwan Application Serial Number 94137631, filed Oct. 27, 2005, the disclosure of which is hereby incorporated by reference herein in its entirety.

### BACKGROUND

1. Field of Invention

The present invention relates to an improved parallel full-color organic light-emitting display (OLED) device and a manufacturing method thereof, which not only improves the transmission and the color saturation of each light source, but also improves the yield.

2. Description of Related Art

The way in which full color display is achieved on a display device determines the success or failure of the device. Two methods used for achieving full color display on an OLED display are listed below:

1. Individual R, G, B pixels method: the organic light-emitting components of red, green and blue are disposed side by side. By mixing the three colored lights generated by those organic light-emitting components, full-color display can be achieved.

However, the individual R, G, B pixels display needs several evaporating steps and mask aiming steps to produce organic light-emitting layers of different colors, which complicates the process and makes the evaporating steps and mask aiming steps more difficult such that the yield decreases and the cost increases.

2. Color filter method: at least one organic light-emitting layer which generates a white light is disposed, and a sophisticated color filter is used. The white light is filtered by the color filter to achieve full-color display.

When a display device uses a color filter to generate a full-color display, a large portion of white light is filtered out causing insufficient brightness and wasting power.

FIG. 1 shows the sectional drawing of a conventional OLED device of the individual R, G, B pixels display, the OLED device 200 has an organic light-emitting layer 23 disposed on the substrate 11, the organic light-emitting layer 23 includes a first organic light-emitting layer 231, a second organic light-emitting layer 233 and a third organic light-emitting layer 235. The first light source S1, the second light source S2 and the third light source S3 respectively generated by the first organic light-emitting layer 231, the second organic light-emitting layer 233 and the third organic light-emitting layer 235 are independent red, green and blue lights. By mixing the red, green and blue lights appropriately, the OLED device 200 can have a full-color display.

Before the organic light-emitting layer 23 is disposed on the substrate 11, masks aiming processes are needed. The disposing of the organic light-emitting layer 23 could be affected if there is an inaccuracy during the masks aiming processes. For example, if there is an inaccuracy during the masks aiming processes of the second organic light-emitting layer 233, the position of the second organic light-emitting layer 233 can be incorrect and an error area 239 produced. Because the second organic light-emitting layer 233 doesn't cover the error area 239, the error area 239 cannot generate the second light source S2 such that the operation area of the second organic light-emitting layer 233 is reduced, and the brightness of the second light source S2 and the displaying quality of the display is affected.

For the foregoing reasons, there is a need for a new improved parallel full-color organic light-emitting display device, which can overcome the yield loss caused by the evaporating and the mask aiming processes such that the cost can be reduced and the yield can be improved. In addition, the light transmission and the color saturation can be improved, which are the main improvements of the present invention.

### SUMMARY

According to one embodiment of the present invention, an improved parallel full-color organic light-emitting display (OLED) device, with a plurality of pixels disposed on a substrate. Each of the pixels includes a first electrode, a first organic light-emitting layer, a second organic light-emitting layer, a third organic light-emitting layer, a fourth organic light-emitting layer and a second electrode; the first electrode disposed on the substrate defined as a first sub-pixel area, a second sub-pixel area and a third sub-pixel area; the first organic light-emitting layer, the second organic light-emitting layer and the third organic light-emitting layer are disposed on the first sub-pixel area, the second sub-pixel area and the third sub-pixel area individually; the fourth organic light-emitting layer is disposed above the first sub-pixel area, the second sub-pixel area and the third sub-pixel area; the second electrode is disposed on the first organic light-emitting layer, the second organic light-emitting layer, the third organic light-emitting layer and the fourth organic light-emitting layer.

According to another embodiment of the present invention, an improved parallel full-color OLED device with a plurality of pixels disposed on a substrate, each of the pixels includes a first electrode, a first organic light-emitting layer, a second organic light-emitting layer, a fourth organic light-emitting layer and a second electrode. The first electrode is defined as a first sub-pixel area, a second sub-pixel area and a third sub-pixel area disposed on the substrate; the first organic light-emitting layer and the second organic light-emitting layer are disposed on the first sub-pixel area and the second sub-pixel area individually; the fourth organic light-emitting layer is disposed on the first sub-pixel area, the second sub-pixel area and the third sub-pixel area; the second electrode is disposed on the first organic light-emitting layer, the second organic light-emitting layer and the fourth organic light-emitting layer.

According to another embodiment of the present invention, the forming method of a pixel of an improved parallel full-color OLED device includes forming a first electrode on the substrate; defining a first sub-pixel area, a second sub-pixel area and a third sub-pixel area of the first electrode; covering the second sub-pixel area and the third sub-pixel area with a first mask; aiming the first sub-pixel area with a first evaporating source, and evaporating a first organic light-emitting layer to form the first organic light-emitting layer; covering the first sub-pixel area and the third sub-pixel area with a second mask; aiming the second sub-pixel area with a second evaporating source, and evaporating a second organic light-emitting layer to form the second organic light-emitting layer; aiming the first sub-pixel area, the second sub-pixel area and the third sub-pixel area with a fourth evaporating source and a fully open mask, evaporating a fourth organic light-emitting layer to form the fourth organic light-emitting layer; and forming a second electrode above the first organic light-emitting layer, the second organic light-emitting layer and the fourth organic light-emitting layer.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is the sectional drawing of conventional OLED device;

FIG. 2 is the sectional drawing of the improved parallel full-color OLED device according to one embodiment of the present invention;

FIG. 2A is the sectional drawing of one embodiment of the present invention;

FIG. 3 is the sectional drawing of another embodiment of the present invention;

FIG. 4 is the sectional drawing of another embodiment of the present invention;

FIG. 5 is the sectional drawing of another embodiment of the present invention; and

FIG. 6A, FIG. 6B, FIG. 6C, FIG. 6D are the sectional drawings of each process steps according to another embodiment of the present invention.

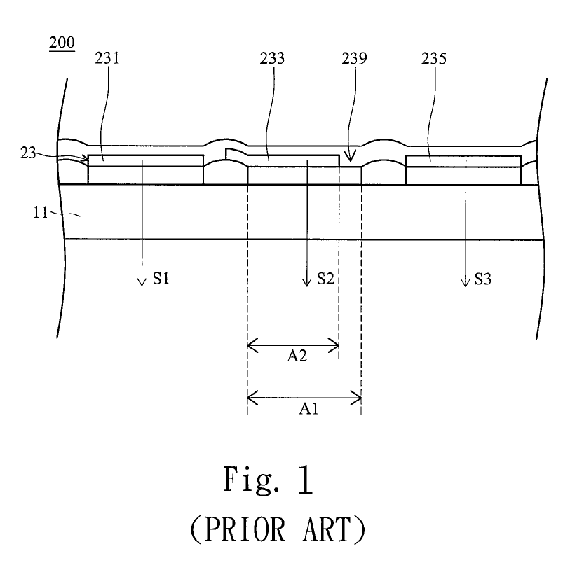

### DESCRIPTION OF THE PREFERRED EMBODIMENTS

Reference will now be made in detail to the present embodiments of the invention, examples of which are illustrated in the accompanying drawings. Wherever possible, the same reference numbers are used in the drawings and the description to refer to the same or like parts.

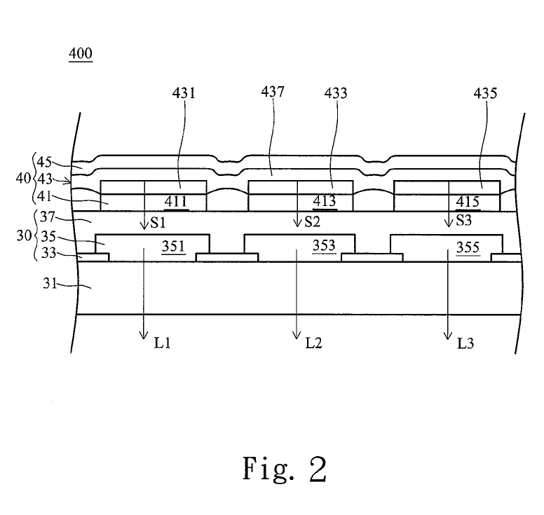

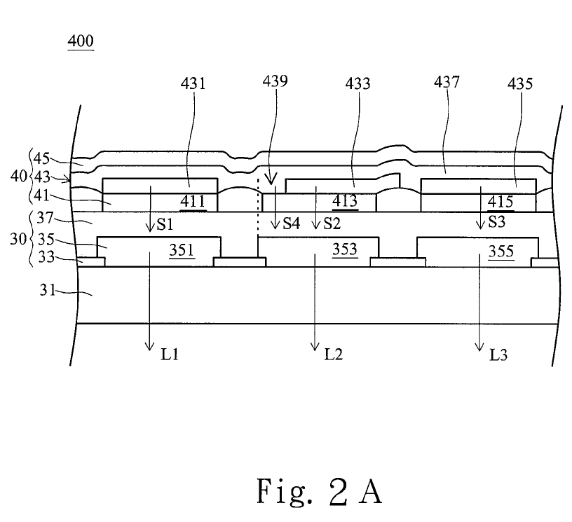

FIG. 2 and FIG. 2A show the sectional drawings of the improved parallel full-color OLED device according to one embodiment of the present invention. To describe the embodiments of the presentation invention clearly, the drawings here show a single pixel. The OLED device 400 essentially includes a substrate 31 and an organic light-emitting component 40; the organic light-emitting component 40 includes a first electrode 41, an organic light-emitting layer 43 and a second electrode 45. The organic light-emitting layer 43 includes a first organic light-emitting layer 431, a second organic light-emitting layer 433, a third organic light-emitting layer 435 and a fourth organic light-emitting layer 437.

The first electrode 41, is defined as a first sub-pixel area 411, a second sub-pixel area 413 and a third sub-pixel area 415, disposed on the substrate 31. The first organic light-emitting layer 431 is disposed on the first sub-pixel area 411, the second organic light-emitting layer 433 is disposed on the second sub-pixel area 413, the third organic light-emitting layer 435 is disposed on the third sub-pixel area 415, the fourth organic light-emitting layer 437 is disposed above the first sub-pixel area 411, the second sub-pixel area 413 and the third sub-pixel area 415. The first organic light-emitting layer 431, the second organic light-emitting layer 433, the third organic light-emitting layer 435 and the fourth organic light-emitting layer 437 are overlapped, so the fourth organic light-emitting layer 437 can be disposed above or under the first organic light-emitting layer 431, the second organic light-emitting layer 433 and the third organic light-emitting layer 435. The second electrode 45 is disposed above the first organic light-emitting layer 431, the second organic light-emitting layer 433, the third organic light-emitting layer 435 and the fourth organic light-emitting layer 437.

The OLED device 400 further includes a color filter 30 formed between the substrate 31 and the organic light-emitting component 40. The color filter 30 includes a black matrix 33 formed on the substrate 31. The first color filter layer 35 (photo resist) formed on the black matrix 33 and the substrate 31 filters the light. The first color filter layer 35 includes a first photo resist 351 (such as R), a second photo resist 353 (such as G) and a third photo resist 355 (such as B). An over coat barrier unit 37 formed on the black matrix 33 and first color filter layer 35 can be an over coat or a barrier layer or both.

A first photo resist 351, a second photo resist 353 and a third photo resist 355 correspond to the vertical extension regions of the first sub-pixel area 411, the second sub-pixel area 413 and the third sub-pixel area 415 respectively.

Thus, the first light source S1 generated by the first organic light-emitting layer 431 and the fourth organic light-emitting layer 437 can pass through the first photo resist 351 such that a filtered first color light L1 is generated, in which the first organic light-emitting layer 431 and the fourth organic light-emitting layer 437 are overlapped; the second light source S2 generated by the second organic light-emitting layer 433 and the fourth organic light-emitting layer 437 can pass through the second photo resist 353 such that a filtered second color light L2 is generated, in which second organic light-emitting layer 433 and the fourth organic light-emitting layer 437 are overlapped; the third light source S3 generated by the third organic light-emitting layer 435 and the fourth organic light-emitting layer 437 can pass through the third photo resist 355 such that a filtered third color light L3 is generated, in which the third organic light-emitting layer 435 and the fourth organic light-emitting layer 437 are overlapped. By mixing the first color light L1, the second color light L2 and the third color light L3, a full-color OLED device 400 can be achieved. The color shift caused by different attenuation effect of the light sources can be eliminated with the disposing of the color filter 30 and the fourth organic light-emitting layer 437.

As shown in FIG. 2, the first organic light-emitting layer 431 generates a red light source or an orange light source; the second organic light-emitting layer 433 generates a green light source; the third organic light-emitting layer 435 generates a blue light source; and the fourth organic light-emitting layer 437 generates a white light source. The first photo resist 351, the second photo resist 353 and the third photo resist 355 are a red resist R (351), a green resist G (353) and a blue resist B (355) respectively. The first color light L1, the second color light L2 and the third color light L3 are red, green and blue lights respectively.

Only light with specific wavelengths can pass through the first color filter layer 35, which can be used to filter the lights. For example, when the white light source tries to pass through the photo resist 351, if light with wavelengths in the visible wavelength range of 640 nm˜770 nm can pass through the first photo resist 351, then only light with wavelengths in the range 640 nm˜770 nm can pass through the photo resist 351, all the other lights are blocked. As a result, the light can be filtered. However, when white light is displayed, the brightness is reduced. Because all the other lights are blocked by the photo resist 351 except lights with wavelengths in the range of 640 nm˜770 nm, when white light tries to pass the photo resist 351, only 25% of white light can pass through the photo resist 351, reducing the brightness.

On the contrary, because lights with wavelengths in the range 640nm˜770 nm can pass through the first photo resist 351, a large portion (above 80%) of the red light which has a wavelength in the range 650˜760 can pass through the first photo resist 351.

By disposing the fourth organic light-emitting layer 437, the yield loss caused by the inaccurate masks aiming process during the disposing of the first organic light-emitting layer 431, the second organic light-emitting layer 433 or the third organic light-emitting layer 435 can be overcome. As shown in FIG. 2A, if the second organic light-emitting layer 433 is inaccurate during the mask aiming process, an error area 439 located on the vertical extension region of the second photo resist 353, which doesn't have the second organic light-emitting layer 433 disposed on it, is produced. Luckily, because the fourth organic light-emitting layer 437 covers the second organic light-emitting layer 433 such that the fourth organic light-emitting layer 437 also covers the error area 439, so the fourth light source S4 generated by the fourth organic light-emitting layer 437 disposed on the error area 439 can go from the first electrode 41 and pass through the second photo resist 353. In addition, if the fourth light source S4 is a white light source, the second color light L2 with a wavelength allowable by the second photo resist 353 (the second photo resist 353 can transmit lights with such wavelength) is generated after the white light passes the second photo resist 353.

Therefore, the yield loss can be overcome by disposing the fourth organic light-emitting layer 437, in which the yield loss is due to the inaccurate masks aiming process while disposing the first organic light-emitting layer 431, the second organic light-emitting layer 433 or the third organic light-emitting layer 435. In other words, even if the first organic light-emitting layer 431, the second organic light-emitting layer 433 and the third organic light-emitting layer 435 are inaccurately disposed, the display quality won't be affected, so the yield can be improved.

In this embodiment, the OLED device 400 further includes several thin film transistors (not shown), each of the thin film transistors is electrically connected to the first electrode 41 of the first sub-pixel area 411, the second sub-pixel area 413 or the third sub-pixel area 415 to form an active matrix OLED device 400. The active matrix OLED device can be formed by a color-filter-on-array (COA) method or by array-on-color-filter (AOC) method.

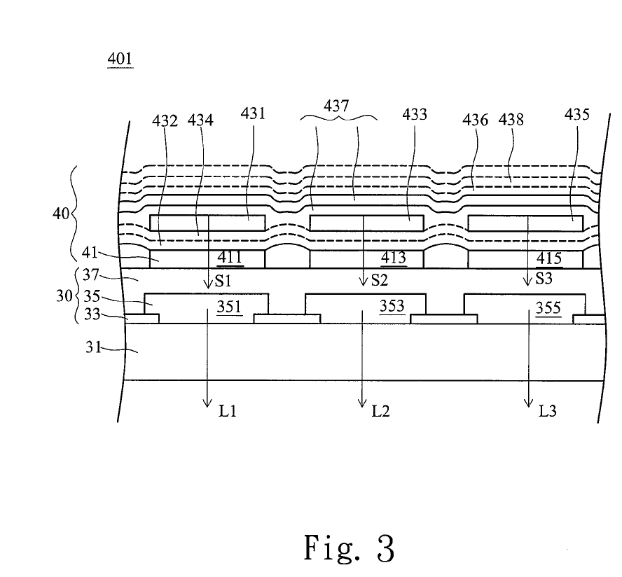

FIG. 3 shows the sectional drawings according to another embodiment of the present invention. Because the disposing of the substrate 31, the disposing of the color filter 30 and the first electrode 41 of the OLED device 401 are the same with those disposing of the OLED device 400, so the description of the disposing is skipped. As shown in FIG. 3 the first organic light-emitting layer 431, the second organic light-emitting layer 433, the third organic light-emitting layer 435 and the fourth organic light-emitting layer 437 of the organic light-emitting component 40 can be chosen from one of: a hole injection layer 432, a hole transport layer 434, an electron transport layer 436, an electron injection layer 438 and a combination thereof. For example, the hole injection layer 432 and the hole transport layer 434 can initially be disposed on the first electrode 41, then the first organic light-emitting layer 431, the second organic light-emitting layer 433 and the third organic light-emitting layer 435 can be disposed on the hole transport layer 434. Next, the fourth organic light-emitting layer 437 can be disposed above the first organic light-emitting layer 431, the second organic light-emitting layer 433 and the third organic light-emitting layer 435. Finally, the Electron Transport Layer 436 and the Electron Injection Layer 438 are disposed on the fourth organic light-emitting layer 437. The hole injection layer 432, the hole transport layer 434, the Electron Transport Layer 436, and the Electron Injection Layer 438 are disposed between the first electrode 41 and the second electrode 45.

The first organic light-emitting layer 431, the second organic light-emitting layer 433, the third organic light-emitting layer 435 and the fourth organic light-emitting layer 437 can be a single layer type or a multiple layer type. For example, the first organic light-emitting layer 431, the second organic light-emitting layer 433 and the third organic light-emitting layer 435 are single layer types, and the fourth organic light-emitting layer 437 is a multiple layer type.

The first organic light-emitting layer 431, the second organic light-emitting layer 433, the third organic light-emitting layer 435 and the fourth organic light-emitting layer 437 can also be a doped organic light-emitting layer composed of at least one Host Emitter doped with a Dopant, which can also generate various color light sources.

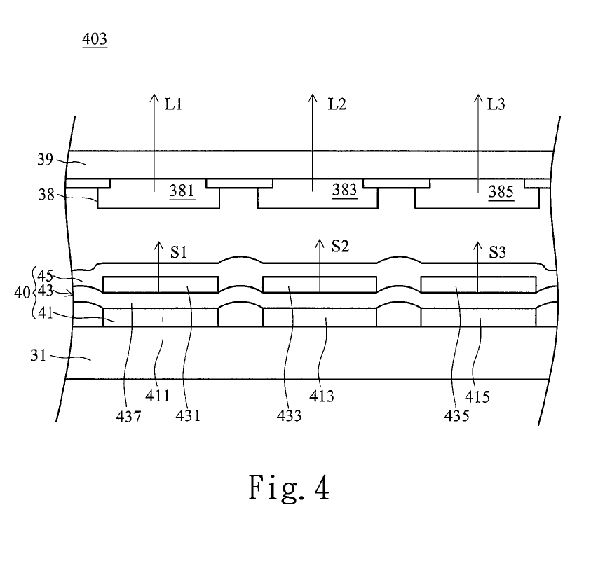

FIG. 4 shows the sectional drawings of another embodiment of the present invention. The OLED device 403 includes a substrate 31 and an organic light-emitting component 40, which have the same disposing with the substrate 31 and organic light-emitting component 40 as shown in FIG. 2. A seal panel 39 is disposed on the substrate 31 which doesn't have an organic light-emitting component 40 disposed on it, thus the organic light-emitting component 40 can be protected by the disposing of the seal panel 39. A second color filter layer 38, disposed on the bottom of the seal panel 39, has a fourth photo resist 381, a fifth photo resist 383 and a sixth photo resist 385, in which the fourth photo resist 381, the fifth photo resist 383 and the sixth photo resist 385 correspond to vertical extension regions of the first sub-pixel area 411, the second sub-pixel area 413 and the third sub-pixel area 415 individually. Because the first light source S1, the second light source S2 and the third light source S3 generated by the organic light-emitting component 40 are filtered by the second color filter layer 38. The second electrode 45 can be made with a transparent conductive material such that the first light source S1, the second light source S2 and the third light source S3 can transmit the second electrode 45, which together make the OLED device 403 a top-emission device.

Again, the yield loss can be overcome and the yield can be improved by disposing the fourth organic light-emitting layer 437, in which the yield loss is due to the inaccurate masks aiming process when the first organic light-emitting layer 431, the second organic light-emitting layer 433 and the third organic light-emitting layer 435 are disposed.

The OLED device 403 further includes several thin film transistors (not shown), each of the thin film transistors is electrically connected to the first electrode 41 of the first sub-pixel area 411, the second sub-pixel area 413 or the third sub-pixel area 415 to form the Active Matrix OLED device 403.

Please refer to FIG. 2 and FIG. 4 simultaneously. As shown in FIG. 4, if there was a color filter 30 (not shown), with a color filter layer 35 (not shown), disposed between the substrate 31 and the organic light-emitting component 40, the OLED device 403 became a bottom-emission OLED device 400 as shown in FIG. 2. Likewise, the OLED device 400 as shown in FIG. 2 becomes the top-Emission OLED device 403 as shown in FIG. 4 if the seal panel 39, with the second color filter layer 38 disposed under it, is disposed on the substrate 31 of OLED device 400. Of course, the seal panel 39, with the second color filter layer 38 disposed under it, can be disposed on the substrate 31 to cover the organic light-emitting component 40 simultaneously when the color filter 30 with the first color filter layer 35 is disposed between the substrate 31 and the organic light-emitting component 40, to obtain the double-faced OLED device.

Several thin film transistors can also be disposed in the OLED device, which can have light emission in both directions, in which each of the thin film transistors is electrically connected to the first electrode 41 of the first sub-pixel area 411, the second sub-pixel area 413 or the third sub-pixel area 415.

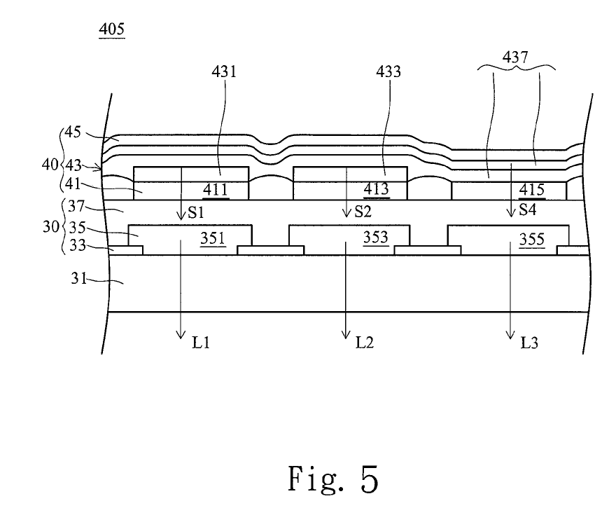

FIG. 5 shows the sectional drawings of another embodiment of the present invention. The disposing of the substrate 31 and an organic light-emitting component 40 of OLED device 405 is the same with the disposing of the substrate 31 and organic light-emitting component 40 of OLED device 400 as shown in FIG. 2. The difference between FIG. 5 and FIG. 2 is that the organic light-emitting layer 43 of the organic light-emitting component 40 in the OLED device 405 includes only the first organic light-emitting layer 431, the second organic light-emitting layer 433 and the fourth organic light-emitting layer 437.

In FIG. 5, the organic light-emitting component 30 includes the first electrode 41, the organic light-emitting layer 43 and the second electrode 45. The first sub-pixel area 411, the second sub-pixel area 413 and third sub-pixel area 415 are defined on the first electrode 41. The first organic light-emitting layer 431 is disposed on the first sub-pixel area 411, and the second organic light-emitting layer 433 is disposed on the second sub-pixel area 413. The fourth organic light-emitting layer 437 is disposed above the first sub-pixel area 411, the second sub-pixel area 413 and third sub-pixel area 415. The disposing between the first organic light-emitting layer 431 and the fourth organic light-emitting layer 437, and the disposing between the second organic light-emitting layer 433 and the fourth organic light-emitting layer 437 are overlapped such that the fourth organic light-emitting layer 437 can be disposed on the first organic light-emitting layer 431 and the second organic light-emitting layer 433. The second electron 45 can be disposed on the organic light-emitting layer 43.

The OLED device 405 further includes a color filter 30, with the same disposing as shown in FIG. 2, is formed between the substrate 31 and the organic light-emitting component 40. The structure of color filter 30 of the OLED device 405 is the same as that shown in FIG. 2, so the detail description can be skipped.

The first light source S1 generated by the first organic light-emitting layer 431 can be a red light source or an orange light source, the second light source S2 generated by the second organic light-emitting layer 433 can be a blue light source, and the fourth light source S4 generated by the fourth organic light-emitting layer 437 can be a white light source. The fourth organic light-emitting layer 437 can be a multiple layer type organic light-emitting layer. By mixing different colors generated by different layers, a white light source can be produced. For example, if the fourth organic light-emitting layer 437 is a two layer type organic light-emitting layer, in which one layer is used to generate the blue light source, the other is used to generate the orange, the yellow or the red light source. By mixing the light source generated by these two layers, the fourth light source S4 generated by the fourth organic light-emitting layer 437 can be a white light source.

According to the description stated above, the embodiment shown in FIG. 5 can be designed as a bottom-emission or a double-faced OLED device. The bottom-emission OLED device can be made by disposing the seal panel 39, with the second color filter layer 38, on the substrate 31 to cover the organic light-emitting component 40, in which the color filter 30 with the color filter layer 35 not disposed between the substrate 31 and the organic light-emitting component 40. The double-faced OLED device needs both the seal panel 39, with the second color filter layer 38, and the color filter 30, with the first color filter layer 35.

In this embodiment (shown in FIG. 5), several thin film transistors can also be disposed in the OLED device 405, in which each of the thin film transistors is electrically connected to the first electrode 41 of the first sub-pixel area 411, the second sub-pixel area 413 or the third sub-pixel area 415, which forms the active matrix OLED device 405.

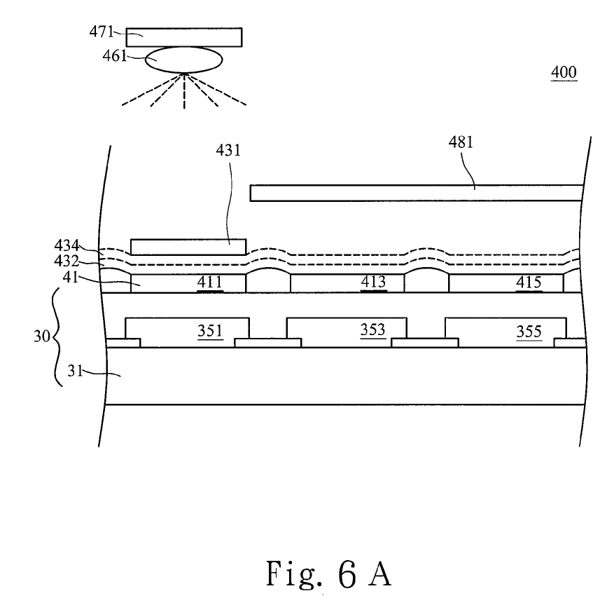

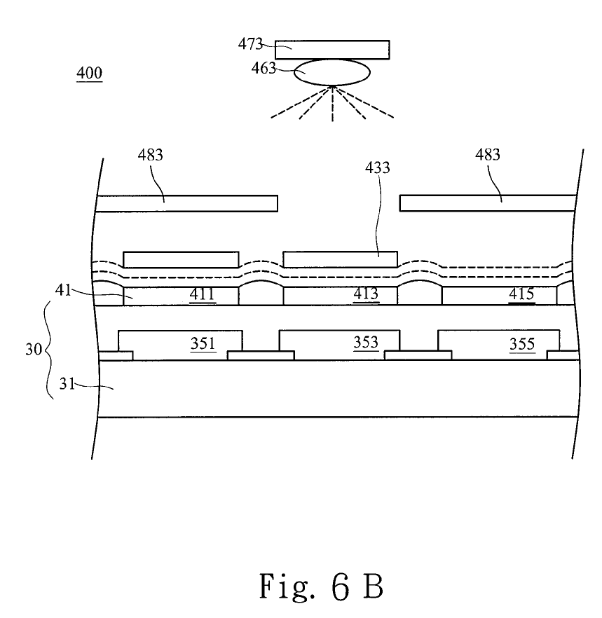

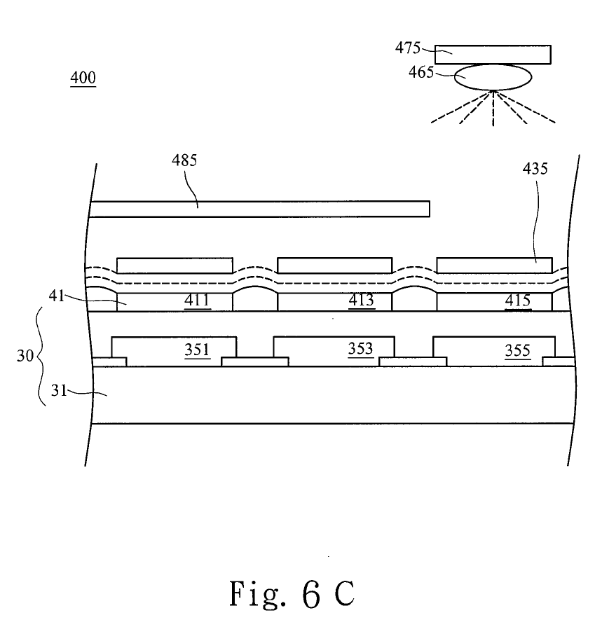

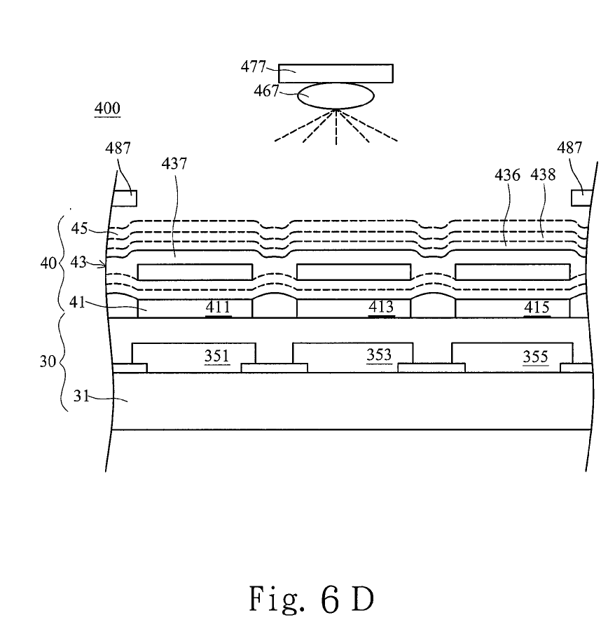

FIG. 6A to FIG. 6D show the sectional drawings of the evaporating processes of the improved parallel OLED device of embodiments of the present invention. The manufacturing steps of OLED device 400 essentially includes: after the first electrode 41 has been disposed, the hole injection layer 432 or the hole transport layer 434 is disposed on the first electrode 41 by evaporating. And the first organic light-emitting layer 431, the second organic light-emitting layer 433, the third organic light-emitting layer 435 and the fourth organic light-emitting layer 437 are disposed on the hole transport layer 434. The first sub-pixel area 411, the second sub-pixel area 413 and third sub-pixel area 415 are defined on the first electrode 41.

Refer to FIG. 6A. In the beginning, a first mask 481 is disposed on the vertical extension of the second sub-pixel area 413 and of the third sub-pixel area 415, then evaporating the first organic light-emitting layer 431 with a first evaporating source 471. As a result, the first organic light-emitting layer 431 is formed on the first electrode 41, which is on the vertical extension region of the first sub-pixel area 411. The first organic light-emitting material 461 of the first evaporating source 471 is selected according to the color of the first photo resist 351. For example, if the first photo resist 351 is a red resist, an organic light-emitting material which generates the red light source is chosen as the first organic light-emitting material 461.

Refer to FIG. 6B. In addition, after a second mask 483 has been disposed on the vertical extension regions of the first sub-pixel area 411 and of the third sub-pixel area 415, the second organic light-emitting layer 433 is evaporated with a second evaporating source 473. As a result, the second organic light-emitting layer 433 is formed on the first electrode 41, which is on the vertical extension region of the second sub-pixel area 413. The second organic light-emitting material 463 of the second evaporating source 473 is selected according to the color of the second photo resist 353. For example, if the second photo resist 353 is a green resist, an organic light-emitting material which generates the green light source is chosen as the second organic light-emitting material 463.

Refer to FIG. 6C. After a third mask 485 has been disposed on the vertical extension region of the first sub-pixel area 411 and of the second sub-pixel area 413, the third organic light-emitting layer 435 is evaporated with a third evaporating source 475. As a result, the third organic light-emitting layer 435 is formed on the first electrode 41, which is on the vertical extension region of the third sub-pixel area 415. The third organic light-emitting material 465 of the third evaporating source 475 is selected according to the color of the third photo resist 355. For example, if the third photo resist 355 is a blue resist, an organic light-emitting material which generates the blue light source is chosen as the third organic light-emitting material 465.

Refer to FIG. 6D. When the first organic light-emitting layer 431, the second organic light-emitting layer 433 and the third organic light-emitting layer 435 have been disposed, the fourth organic light-emitting layer 437 is evaporated with a fourth evaporating source 477 and a fully-open mask 487. The fourth organic light-emitting layer 437 is formed on the first organic light-emitting layer 431, the second organic light-emitting layer 433 and the third organic light-emitting layer 435. A light-emitting material which generates the white light source is chosen as the fourth organic light-emitting material 467 of the fourth evaporating source 477.

Obviously, the disposing sequence of the first organic light-emitting layer 431, the second organic light-emitting layer 433, the third second organic light-emitting layer 435 and the fourth second organic light-emitting layer 437 can be changed when it comes to practical applications. For example, the fourth organic light-emitting layer 437 can be disposed first, followed by the disposing of the first organic light-emitting layer 431, the second organic light-emitting layer 433 and the third second organic light-emitting layer 435.

After the first organic light-emitting layer 431, the second organic light-emitting layer 433, the third organic light-emitting layer 435 have been disposed, some other manufacturing processes of the OLED device 400 can be continued. For example, the electron transport layer 436 and/or the electron injection layer 438 and the second electrode 45 are formed in order on the fourth second organic light-emitting layer 437 by evaporating, as the dash lines shown in FIG. 6D, which accomplishes the manufacturing process of the OLED device 400.

As the embodiment shown in FIG. 5, the first electrode 41 can be disposed on the substrate 31 by evaporating. After that, the first mask is disposed on the vertical extension regions of the second sub-pixel area 413 and the third sub-pixel area 415, then the first organic light-emitting layer 431 is evaporated with a first evaporating source. After the first organic light-emitting layer 431 has been formed, the second mask is disposed on the vertical extension regions of the first sub-pixel area 411 and the third sub-pixel area 415, then the second organic light-emitting layer 433 is evaporated with a second evaporating source. After that, the fourth organic light-emitting layer 437 is evaporated with a fourth evaporating source and a fully-open mask to form the fourth organic light-emitting layer 437 on the vertical extension regions of the first sub-pixel area 411, the second sub-pixel area 413 and the third organic light-emitting layer 435. Finally, the second electrode 45 is formed on the organic light-emitting layer 43.

Compared with the conventional OLED devices formed by R, G, B organic light-emitting components disposed individually, the yield loss of the OLED device 400 caused by the inaccurate masks aiming process can be improved by using the evaporating process which evaporates the organic light-emitting layer 43 as stated above.

Obviously, the manufacturing process stated above can also be used in Active Matrix OLED device, so the detail description is omitted.

In total, according to the embodiments of the present invention, the light transmission and the color saturation can be improved. In addition, the yield loss caused by the evaporating and the mask aiming processes can be overcome such that the productive can be promoted.

Any element in a claim that does not explicitly state “means for” performing a specified function, or “step for” performing a specific function, is not to be interpreted as a “means” or “step” clause as specified in 35 USC § 112, ¶6. In particular, the use of “step of” in the claim herein is not intended to invoke the provisions of 35 USC § 112, ¶6.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An improved parallel full-color organic light-emitting display (OLED) device, with a plurality of pixels disposed on a substrate, each of the pixels comprising:
a first electrode disposed on the substrate, the first electrode is defined as a first sub-pixel area, a second sub-pixel area and a third sub-pixel area;
a first organic light-emitting layer, disposed on the first sub-pixel area;
a second organic light-emitting layer, disposed on the second sub-pixel area;
a third organic light-emitting layer, disposed on the third sub-pixel area;
a fourth organic light-emitting layer, disposed on the first sub-pixel area, the second sub-pixel area and the third sub-pixel area; and
a second electrode, disposed on the first organic light-emitting layer, the second organic light-emitting layer, the third organic light-emitting layer and the fourth organic light-emitting layer.

2. The OLED device of claim 1, wherein the fourth organic light-emitting layer is disposed above or below the first organic light-emitting layer, the second organic light-emitting layer and the third organic light-emitting layer.

3. The OLED device of claim 1, further comprising a first color filter layer disposed between the substrate and the first electrode, in which the first color filter layer comprises a first photo resist, a second photo resist and a third photo resist which separately correspond to the vertical extension regions of the first sub-pixel area, the second sub-pixel area and the third sub-pixel area.

4. The OLED device of claim 3, further comprising a plurality of thin film transistors, in which each of the thin film transistors is electrically connected to the first electrode of the first sub-pixel area, the second sub-pixel area or the third sub-pixel area.

5. The OLED device of claim 3, further comprising a seal panel disposed on the substrate, in which a second color filter layer is disposed on the bottom of the seal panel, wherein the second color filter layer comprises a fourth photo resist, a fifth photo resist and a sixth photo resist separately correspond to the vertical extension regions of the first sub-pixel area, the second sub-pixel area and the third sub-pixel area.

6. The OLED device of claim 5, further comprising a plurality of thin film transistors, in which each of the thin film transistors is electrically connected to the first electrode of the first sub-pixel area, the second sub-pixel area or the third sub-pixel area.

7. The OLED device of claim 1, further comprising a seal panel disposed on the substrate, in which a second color filter layer is disposed on the bottom of the seal panel, wherein the second color filter layer comprises a fourth photo resist, a fifth photo resist and a sixth photo resist separately correspond to the extension regions of the first sub-pixel area, the second sub-pixel area and the third sub-pixel area.

8. The OLED device of claim 7, further comprising a plurality of thin film transistors, in which each of the thin film transistors is electrically connected to the first electrode of the first sub-pixel area, the second sub-pixel area or the third sub-pixel area.

9. The OLED device of claim 1, wherein the first organic light-emitting layer, the second organic light-emitting layer, the third organic light-emitting layer, and the fourth organic light-emitting layer are selected from the group consisting of a single layer type organic light-emitting layer, a multiple layer type organic light-emitting layer and a doped type organic light-emitting layer.

10. The OLED device of claim 1, further comprising:
a layer selected from a group consisting of a hole injection layer, a hole transport layer, an electron transport layer, an electron injection layer and a combination thereof disposed between the first electrode and the second electrode.

11. The OLED device of claim 1, wherein the first organic light-emitting layer generates a red light source or an orange light source, the second organic light-emitting layer generates a green light source, the third organic light-emitting layer generates a blue light source and the fourth organic light-emitting layer generates a white light source.

12. An improved parallel full-color organic light-emitting display (OLED) device, with a plurality of pixels disposed on a substrate, each of the pixels comprising:
a first electrode disposed on the substrate, in which the first electrode is defined as a first sub-pixel area, a second sub-pixel area and a third sub-pixel area;
a first organic light-emitting layer, disposed on the first sub-pixel area;
a second organic light-emitting layer, disposed on the second sub-pixel area;
a fourth organic light-emitting layer, disposed on the first sub-pixel area, the a second sub-pixel area and the third sub-pixel area; and
a second electrode, disposed on the first organic light-emitting layer, the second organic light-emitting layer and the fourth organic light-emitting layer.

13. The OLED device of claim 12, wherein the fourth organic light-emitting layer is disposed above or under the first organic light-emitting layer and the second organic light-emitting layer.

14. The OLED device of claim 12, further comprising a first color filter layer disposed between the substrate and the first electrode, in which the first color filter layer comprises a first photo resist, a second photo resist and a third photo resist which separately correspond to the vertical extension regions of the first sub-pixel area, the second sub-pixel area and the third sub-pixel area.

15. The OLED device of claim 14, further comprising a plurality of thin film transistors, in which each of the thin film transistors is electrically connected to the first electrode of the first sub-pixel area, the second sub-pixel area or the third sub-pixel area.

16. The OLED device of claim 14, further comprising a seal panel disposed on the substrate, in which a second color filter layer is disposed on the bottom of the seal panel, wherein the second color filter layer comprises a fourth photo resist, a fifth photo resist and a sixth photo resist separately correspond to the vertical extension regions of the first sub-pixel area, the second sub-pixel area and the third sub-pixel area.

17. The OLED device of claim 16, further comprising a plurality of thin film transistors, in which each of the thin film transistors is electrically connected to the first electrode of the first sub-pixel area, the second sub-pixel area or the third sub-pixel area.

18. The OLED device of claim 12, further comprising a seal panel disposed on the substrate, in which a second color filter layer is disposed on the bottom of the seal panel, wherein the second color filter layer comprises a fourth photo resist, a fifth photo resist and a sixth photo resist separately correspond to the vertical extension regions of the first sub-pixel area, the second sub-pixel area and the third sub-pixel area.

19. The OLED device of claim 18, further comprising a plurality of thin film transistors, in which each of the thin film transistors is electrically connected to the first electrode of the first sub-pixel area, the second sub-pixel area or the third sub-pixel area.

20. The OLED device of claim 12, wherein the first organic light-emitting layer generates a red light source or an orange light source, the second organic light-emitting layer generates a green light source, and the fourth organic light-emitting layer generates a white light source.

21. The OLED device of claim 12, wherein the fourth organic light-emitting layer is a multiple layer type organic light-emitting layer.

22. A method for manufacturing a pixel of an improved parallel full-color organic light-emitting display (OLED) device which has a plurality of pixels formed on a substrate, the method comprising:
forming a first electrode on the substrate;
defining a first sub-pixel area, a second sub-pixel area and a third sub-pixel area on the first electrode;
covering the second sub-pixel area and the third sub-pixel area with a first mask;
aiming the first sub-pixel area with a first evaporating source, and evaporating a first organic light-emitting layer to form the first organic light-emitting layer;
covering the first sub-pixel area and the third sub-pixel area with a second mask;
aiming the second sub-pixel area with a second evaporating source, and evaporating a second organic light-emitting layer to form the second organic light-emitting layer;
aiming the first sub-pixel area, the second sub-pixel area and the third sub-pixel area with a fourth evaporating source and a fully open mask, evaporating a fourth organic light-emitting layer to form the fourth organic light-emitting layer; and
forming a second electrode above the first organic light-emitting layer, the second organic light-emitting layer and the fourth organic light-emitting layer.

23. The method of claim 22, further comprising:
covering the first sub-pixel area and the second sub-pixel area with a third mask; and
aiming the third sub-pixel area with a third evaporating source, evaporating the third organic light-emitting layer to form the third organic light-emitting layer.
